(19) United States
(12) Patent Application Publication
(10) Pub. No.: US 2016/0227369 A1
(43) Pub. Date: Aug. 4, 2016

(54) MULTI-LAYER ASSISTANCE DATA CACHING

(71) Applicant: QUALCOMM Incorporated, San Diego, CA (US)

(72) Inventors: Weihua GAO, San Jose, CA (US); Sundar RAMAN, Fremont, CA (US); Sai Pradeep VENKATRAMAN, Santa Clara, CA (US); Gengsheng ZHANG, Cupertino, CA (US)

(21) Appl. No.: 14/811,726

(22) Filed: Jul. 28, 2015

Related U.S. Application Data
(60) Provisional application No. 62/110,341, filed on Jan. 30, 2015.

(51) Int. Cl. H04W 4/02; H04L 29/08

(52) U.S. Cl. CPC H04W 4/023; H04L 67/2842; H04W 88/08

(57) ABSTRACT

A method of organizing positioning assistance data includes: determining that first access points are more likely to be used for determining a position of a mobile device than second access points, the first and second access points being members of a master group of access points, at least the first access points being access points from each of which at least one signal has been received by the mobile device; storing first sets of positioning assistance data, associated with the first access points, in a first cache; and storing second sets of positioning assistance data, associated with the second access points, in a second cache; where the first cache has a quicker access rate than the second cache.

### CROSS-REFERENCE TO RELATED APPLICATIONS

This application claims the benefit of U.S. Provisional Application No. 62/110,341, filed Jan. 30, 2015, entitled “Multi-Layer Assistance Data Caching,” which is incorporated herein by reference in its entirety for all purposes.

### BACKGROUND

Mobile communication device usage has increased exponentially over the years. In the 1970's, mobile phones were incredibly rare, and typically only found in automobiles and thus not truly mobile. In the 1980's, handheld phones gained in popularity, but they were bulky and expensive. In the 1990's, mobile devices became smaller and more affordable and consequently much more common. Today, most persons from young adults and older in most developed countries use a mobile phone or similar device. It is estimated that there are approximately 6.8 billion mobile phones today worldwide, compared to an estimated population of 7.0 billion persons.

Fueling the rise in popularity of mobile phones is not only the size and cost of these devices, but the increased functionality provided by these devices, in particular smart devices. The rise of smart devices, e.g., smartphones, tablets, etc., has carried with it an exponential growth in the number of applications (apps) for use on these devices.

Many apps used by smart devices use the location of the device to provide or enhance the service(s) provided by the apps. To determine the location of a device, the device may use signaling between the device and communication nodes, and positioning assistance data associated with the nodes, such nodes including, e.g., cell towers and WiFi access points (APs). The positioning assistance data include information that the mobile device may use to determine the position of the mobile device, such information including, e.g., identities and locations of the APs, information for accessing Satellite Positioning System (SPS) signals (e.g., ephemeris data), communication protocols, and/or whether an AP is a mobile or stationary AP. Typically, a mobile device will query a server for positioning assistance data and download the positioning assistance data, from the server, for APs in the vicinity of the mobile device for use in determining the location of the mobile device. The server may provide positioning assistance data for the APs in a tile (i.e., partition) in which the mobile device presently resides, with the tile being a geographic region, e.g., a portion of a venue such as a mall, or a portion of a broader geographic region such as a park, a county, a state, a country, or the world, etc. For example, for GTP (GPRS (General Packet Radio Service) Tunneling Protocol) WiFi, a tile may be a portion of the surface of the earth, with the portion being a square that is 1 km on each side. The positioning assistance data may be stored in the mobile device, with new positioning assistance data being downloaded as needed or desired, and with previously stored positioning assistance data being replaced by new positioning assistance data if the capacity for positioning assistance data in the mobile device has been reached. Typically, a smart device may store about 10 tiles of positioning assistance data, with each tile potentially having hundreds of thousands of APs. For simplicity, positioning assistance data may be referred to herein as simply assistance data.

### SUMMARY

An example method of organizing positioning assistance data in a mobile device includes: determining that first access points are more likely to be used by the mobile device for determining a position of the mobile device than second access points, the first access points being distinct from the second access points, the first access points and the second access points being members of a master group of access points associated with positioning assistance data stored by the mobile device, at least the first access points being access points from the master group of access points from each of which at least one signal has been received by the mobile device; storing first sets of positioning assistance data in a first cache of the mobile device, the first sets of positioning assistance data being associated with the first access points; and storing second sets of positioning assistance data in a second cache of the mobile device, the second sets of positioning assistance data being associated with the second access points; where the first cache has a quicker access rate than the second cache such that, on average, a processor of the mobile device can access a desired one of the first sets of positioning assistance data quicker than a desired one of the second sets of positioning assistance data.

Implementations of such a method may include one or more of the following features. Storing the first sets of positioning assistance data includes storing the first sets of positioning assistance data in the first cache such that the first cache stores fewer sets of positioning assistance data than the second cache stores. Determining that first access points are more likely to be used by the mobile device for determining a position of the mobile device than second access points includes ranking access points in the master group of access points in order of likelihood of future use by the mobile device for determining the position of the mobile device. Ranking each of the access points in the master group of access points is based on quantities of signals received by the mobile device from respective access points in the master group of access points by the mobile device. The ranking includes a tradeoff between the quantities of signals received by the mobile device from the respective access points in the master group of access points and respective times since most-recent receipts of signals by the mobile device from the respective access points in the master group of access points. The method further includes removing respective ones of the first sets of positioning assistance data from the first cache in response to a threshold amount of time passing without receiving a signal from each of corresponding ones of the first access points by the mobile device. The method further includes eliminating from consideration as either one of the first access points or one of the second access points, any access point that is identified as a mobile access point.

An example mobile device includes: a processor; a first cache communicatively coupled to the processor; and a second cache communicatively coupled to the processor; where the first cache has a quicker access rate than the second cache such that, on average, the processor can access positioning assistance data stored in the first cache quicker than the processor can access positioning assistance data stored in the second cache; and where the processor is configured to: determine that first access points are more likely to be used by the mobile device for determining a position of the mobile device than second access points, the first access points being distinct from the second access points, the first access points and the second access points being members of a master group of access points associated with positioning assistance data stored by the mobile device, at least the first access points being access points from the master group of access points from each of which at least one signal has been received by the mobile device; store first sets of positioning assistance data in the first cache, the first sets of positioning assistance data being associated with the first access points; and store second sets of positioning assistance data in the second cache, the second sets of positioning assistance data being associated with the second access points.

Implementations of such a mobile device may include one or more of the following features. A storage capacity of the first cache is smaller than a storage capacity of the second cache. To determine that first access points are more likely to be used by the mobile device for determining a position of the mobile device than second access points the processor is configured to rank access points in the master group of access points in order of likelihood of future use by the mobile device for determining the position of the mobile device. The processor is configured to rank access points in the master group of access points based on quantities of signals received by the mobile device from respective access points in the master group of access points, and the first access points are ranked at least as high as a highest-ranked one of the second access points. The processor is configured to rank the access points according to a tradeoff between the quantities of signals received by the mobile device from the respective access points in the master group of access points and respective times since most-recent receipts of signals by the mobile device from the respective access points in the master group of access points. The processor is further configured to remove respective ones of the first sets of positioning assistance data from the first cache in response to a threshold amount of time passing without receiving a signal from each of corresponding ones of the first access points by the mobile device. The processor is further configured to eliminate from consideration as either one of the first access points or one of the second access points, any access point that is identified as a mobile access point.

An example non-transitory processor-readable storage medium, in a mobile device, includes processor-readable instructions configured to cause a processor to: determine that first access points are more likely to be used by the mobile device for determining a position of the mobile device than second access points, the first access points being distinct from the second access points, the first access points and the second access points being members of a master group of access points associated with positioning assistance data stored by the mobile device, at least the first access points being access points from the master group of access points from each of which at least one signal has been received by the mobile device; store first sets of positioning assistance data in a first cache of the mobile device, the first sets of positioning assistance data being associated with the first access points; and store second sets of positioning assistance data in a second cache of the mobile device, the second sets of positioning assistance data being associated with the second access points; where the first cache has a quicker access rate than the second cache such that, on average, a processor of the mobile device can access a desired one of the first sets of positioning assistance data quicker than a desired one of the second sets of positioning assistance data.

Implementations of such a storage medium may include one or more of the following features. The instructions configured to store the first sets of positioning assistance data include instructions configured to cause the processor to store the first sets of positioning assistance data in the first cache such that the first cache stores fewer sets of positioning assistance data than the second cache stores. The instructions configured to cause the processor to determine that the first access points are more likely to be used by the mobile device for determining the position of the mobile device than the second access points include instructions configured to cause the processor to rank access points in the master group of access points in order of likelihood of future use by the mobile device for determining the position of the mobile device. The instructions configured to cause the processor to rank access points in the master group of access points include instructions configured to cause the processor to rank access points in the master group of access points based on quantities of signals received by the mobile device from respective access points in the master group of access points. The instructions configured to cause the processor to rank access points in the master group of access points include instructions configured to cause the processor to rank each of the respective access points in the master group of access points based on a tradeoff between the quantities of signals received by the mobile device from the respective access points in the master group of access points and respective times since most-recent receipts of signals by the mobile device from the respective access points in the master group of access points. The storage medium further includes instructions configured to cause the processor to remove respective ones of the first sets of positioning assistance data from the first cache in response to a threshold amount of time passing without receiving a signal from each of corresponding ones of the first access points by the mobile device. The storage medium further includes instructions configured to cause the processor to eliminate from consideration as either one of the first access points or one of the second access points, any access point that is identified as a mobile access point.

Another example mobile device includes: processing means; a first cache communicatively coupled to the processing means; and a second cache communicatively coupled to the processing means; where the first cache has a quicker access rate than the second cache such that, on average, the processing means can access positioning assistance data stored in the first cache quicker than the processing means can access positioning assistance data stored in the second cache; and where the processing means include: means for determining that first access points are more likely to be used by the mobile device for determining a position of the mobile device than second access points, the first access points being distinct from the second access points, the first access points and the second access points being members of a master group of access points associated with positioning assistance data stored by the mobile device, at least the first access points being access points from the master group of access points from each of which at least one signal has been received by the mobile device; means for storing first sets of positioning assistance data in the first cache, the first sets of positioning assistance data being associated with the first access points; and means for storing second sets of positioning assistance data in the second cache, the second sets of positioning assistance data being associated with the second access points.

Implementations of such a mobile device may include one or more of the following features. A storage capacity of the first cache is smaller than a storage capacity of the second cache. The means for determining that the first access points are more likely to be used by the mobile device for determining a position of the mobile device than second access points the processing means are for ranking access points in the master group of access points in order of likelihood of future use by the mobile device for determining the position of the mobile device. The means for ranking access points in the master group of access points are for ranking access points in the master group of access points based on quantities of signals received by the mobile device from respective access points in the master group of access points, and the first access points are ranked at least as high as a highest-ranked one of the second access points. The means for ranking access points in the master group of access points are for ranking each of the respective access points in the master group of access points according to a tradeoff between the quantities of signals received by the mobile device from the access points in the master group of access points and respective times since most-recent receipts of signals by the mobile device from the respective access points in the master group of access points. The processing means further include means for removing respective ones of the first sets of positioning assistance data from the first cache in response to a threshold amount of time passing without receiving a signal from each of corresponding ones of the first access points by the mobile device. The processing means further include means for eliminating from consideration as either one of the first access points or one of the second access points, any access point that is identified as a mobile access point.

Items and/or techniques described herein may provide one or more of the following capabilities, and/or other capabilities not mentioned. Speed of mobile-based position determination may be increased. Storage resources for positioning assistance data may be reduced. Positioning assistance data from access points that have been inactive may be removed, thus avoiding processing effort to review the positioning assistance data when determining position of a mobile device. Positioning assistance data from access points that are mobile may be omitted from consideration of positioning assistance data to use for determining mobile device position, and may be omitted from storage of potential positioning assistance data to use for determining mobile device position. Further, it may be possible for an effect noted above to be achieved by means other than that noted, and a noted item/technique may not necessarily yield the noted effect.

### BRIEF DESCRIPTION OF THE DRAWINGS

FIG. 1 is a schematic diagram of a communication system.

FIG. 2 is block diagram of a mobile device shown in FIG. 1

FIG. 3 is a functional block diagram of the mobile device shown in FIG. 2.

FIG. 4 is a simplified diagram of a portion of a Freshly Detected AP List.

FIG. 5 is a simplified diagram of example AP records.

FIG. 6 is a block flow diagram of a process of organizing positioning assistance data in the mobile device shown in FIGS. 2-3.

### DETAILED DESCRIPTION

Techniques are discussed for organizing positioning assistance data in a mobile device. For example, a mobile device may use information received in signals from access points to determine a position of the mobile device. To determine the position, the mobile device searches positioning assistance data for associated access points, and finds and accesses positioning assistance data related to the access points from which the mobile device receives signals. To reduce the time used to access the positioning assistance data related to these access points, the mobile device may determine from which access points the mobile device is likely to receive signals, and may search the positioning assistance data for these access points before and/or in a quicker manner than the data for other access points. The positioning data associated with access points from which it is more likely to receive signals, compared to other access points, are stored in a cache from which the positioning data may be more quickly accessed than other cache and/or other memory. The access points, or equivalently the positioning data, may be ranked in order of likelihood of future use for determining the position. Positioning data associated with higher rankings are stored in the quicker-access cache. The ranking may be based on a tradeoff between how many times signals have been received from each access point and a time since a signal was received from each access point. Further, positioning data may be discarded or not considered if the data are related to mobile access points or access points from which no signal has been received recently. Other techniques may be used including, but not limited to, techniques discussed below.

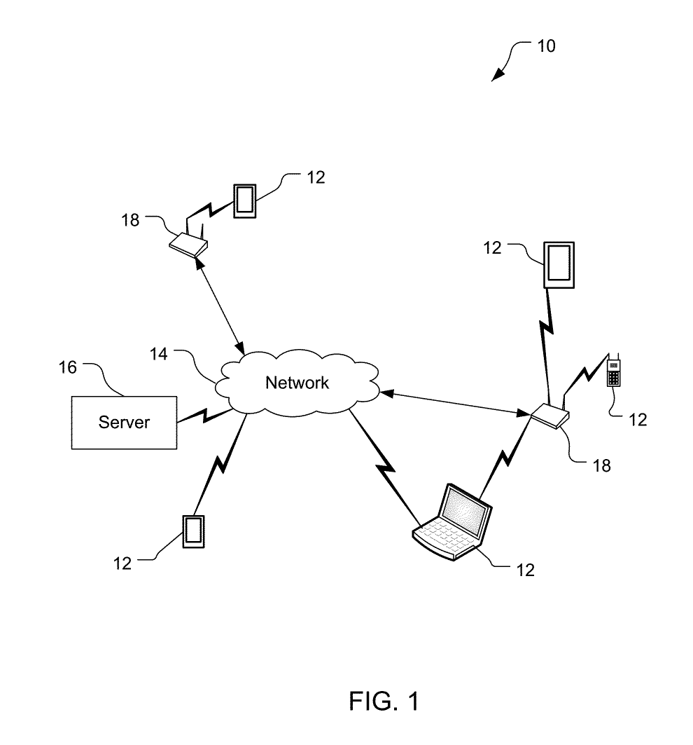

Referring to FIG. 1, a communication system 10 includes mobile devices 12, a network 14, a server 16, and access points (APs) 18. The system 10 is a communication system in that components of the system 10 can communicate with one another directly or indirectly, e.g., via the network 14 and/or one or more of the access points 18 (and/or one or more other devices not shown, such as one or more base transceiver stations). The example mobile devices 12 shown include mobile phones (including smartphones), a laptop computer, and a tablet computer. Still other mobile devices may be used, whether currently existing or developed in the future.

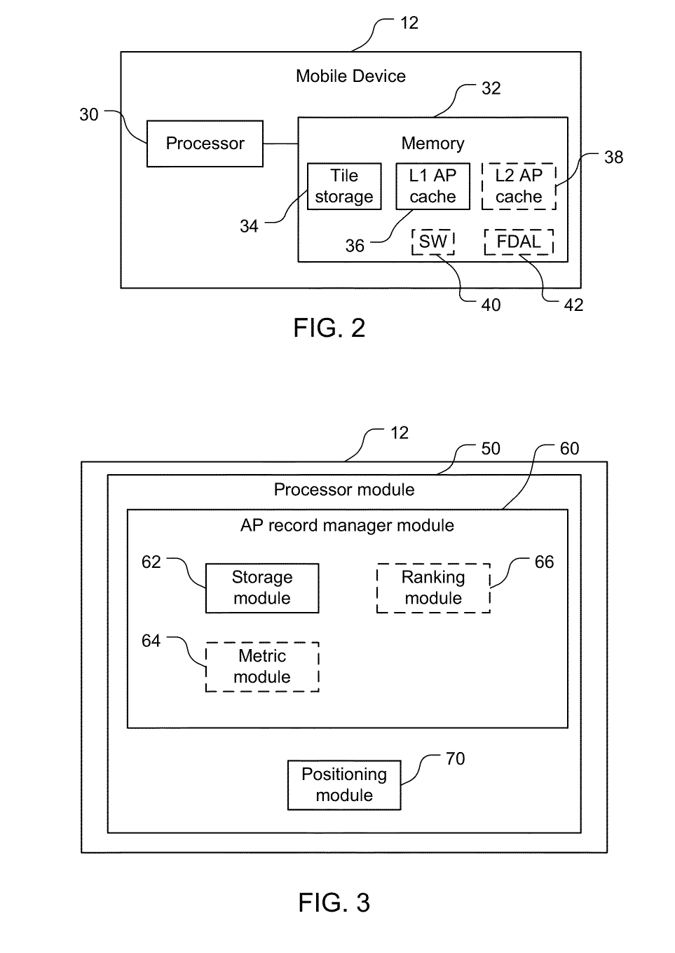

Referring to FIG. 2, an example of one of the mobile devices 12 comprises a processor 30, and a memory 32 including a tile storage 34, an L1 AP cache 36 and (optionally) an L2 AP cache 38, (optionally) software 40, and (optionally) a Freshly Detected AP List (FDAL) 42. The L1 AP cache, the L2 AP cache 38 (if present/used), and any other layer of AP cache may be referred to collectively as the AP cache. The processor 30 is preferably an intelligent hardware device, e.g., a central processing unit (CPU) such as those made or designed by QUALCOMM®, ARM®, Intel® Corporation, or AMD®, a microcontroller, an application specific integrated circuit (ASIC), etc. The processor 30 could comprise multiple separate physical entities that can be distributed in the mobile device 12. The memory 32 may include random access memory (RAM) and/or read-only memory (ROM). The memory 32 is a processor-readable storage medium that may store the software 40 which is processor-readable, processor-executable software code containing instructions that are configured to, when executed, cause the processor 30 to perform various functions described herein (although the description may refer only to the processor 30 performing the functions). Alternatively, the software 40 may not be directly executable by the processor 30 and instead may be configured to cause the processor 30, e.g., when compiled and executed, to perform the functions. The processor 30 is communicatively coupled to the memory 32, that is, the processor 30 and the memory 32 are configured to communicate with each other directly and/or indirectly. The L1 AP cache 36 and the L2 AP cache 38 comprise different layers of the AP cache. While only two layers of AP cache, namely the L1 AP cache 36 and the optional L2 AP cache 38, are shown in the example of FIG. 2, other quantities of layers of cache may be provided in the AP cache.

The tile storage 34 is preferably cache memory, although other forms of memory may be used for the tile storage 34. The tile storage 34 stores AP records as discussed more fully below with respect to FIG. 5. The tile storage 34 may typically hold about 100,000 AP records (although other quantities, higher or lower, of AP records may be held), corresponding to about 10 AP tiles of typical size. The AP tiles comprise AP records for all the APs 18 within a geographic region referred to as a tile. For example, each tile for GTP WiFi (i.e., GPRS (General Packet Radio Service) Tunneling Protocol WiFi) comprises a 1 km by 1 km square partition of the earth. Each GTP WiFi tile may contain thousands, even hundreds of thousands, of APs (that is, records of these APs) as there are presently over 100M APs worldwide.

The L1 (layer 1) AP cache 36 has a quicker access rate than the tile storage and, if used, the L2 (layer 2) AP cache 38. That is, on average, the processor 30 is able to access (i.e., locate and retrieve) an AP record in the L1 AP cache 36 faster (in less time) than the processor 30 is able to access an AP record in the tile storage 34. Thus, a single access in the tile storage 34 may be faster than a single access in the L1 AP cache 36, e.g., if the first AP record reviewed in the tile storage 34 satisfies a search, but over many searches, the average time to access an AP record in the L1 AP cache 36 will be less than the average time to access an AP record in the tile storage 34. The difference in access rates may be due to, for example, the tile storage 34 and the L1 AP cache 36 being different types of memory, e.g., non-cache (e.g., a secure digital (SD) card) vs. cache, with different speeds at which bits of data may be located in and/or read from the memory. The difference in access rates may also or alternatively be due to, for example, the tile storage 34 storing more AP records than the L1 AP cache 36 (the tile storage 34 having a larger storage capacity than the L1 AP cache 36). In this case, an access of an AP record in the tile storage 34 may involve reading many more AP records than an access of an AP record in the L1 AP cache 36. If the L2 AP cache 38 (or more AP cache layers) is used, then the L1 AP cache 36 stores fewer AP records than the L2 AP cache 38 stores such that the L1 AP cache 36 will have a quicker access rate than the L2 AP cache 38 (i.e., the processor 30 can access, on average, an AP record in the AP cachet 26 faster than the processor 30 can access an AP record in the L2 AP cache 38). The same would preferably apply to further layers of AP cache, with each higher layer having a slower access rate. As an example, the tile storage may store about 100,000 AP records, the L1 AP cache 36 may store about 200 AP records, and the L2 AP cache 38 may store about 2,000 AP records.

The layers in the AP cache may be inclusive or exclusive. If the layers in the AP cache are inclusive, then AP records that are in either the L1 AP cache 36 or the L2 AP cache 38 are also stored in the tile storage 34. In the inclusive case, records stored in one layer of the AP cache, e.g., the L1 AP cache 36, are preferably not stored in any other layer of the AP cache, e.g., the L2 AP cache 38. If the layers in the AP cache are exclusive, then AP records that are in either the L1 AP cache 36 or the L2 AP cache 38 are not also stored in the tile storage 34. Thus, for example, when AP records are stored in the L1 AP cache 36 or the L2 AP cache 38, the corresponding AP records are removed from the tile storage 34.

Referring to FIG. 3, with reference to FIG. 2, the mobile device 12 includes a processor module 50 (means for processing) that includes an AP record manager module 60 (means for managing), and a positioning module 70 (means for determining position). The AP record manager module 60 includes a storage module 62, optionally a metric module 64, and optionally a ranking module 66. The modules 50, 60, 62, 64, 66, 70 are functional modules that may be implemented by the processor 30 and the memory 32. Thus, reference to any of the modules 50, 60, 62, 64, 66, 70 performing or being configured to perform a function is shorthand for the corresponding apparatus performing or being configured to perform the function.

The processor module 50 is configured to communicate with the APs 18 to send and receive information to and from the APs 18, including information from which the position of the mobile device 12 may be determined. Such information includes AP records from the APs 18. The positioning module 70 is configured to use AP records stored in the memory 32 along with signals received from multiple ones of the APs 18 to determine the position of the mobile device 12. For example, the positioning module 70 may use one or more trilateration techniques to determine the position of the mobile device 12.

The AP record manager module 60 is configured to organize AP records stored in the memory 32 in order to facilitate and expedite accessing of AP records for use in determining the position of the mobile device 12, and thus to expedite the determination of the position of the mobile device 12. The AP record manager module 60 is configured to determine which AP records are more likely to be used, for example within a predetermined future time frame, for determining the position of the mobile device 12 and to store these AP records such that these records may be accessed more quickly than other AP records that are less likely to be used for determining the position of the mobile device 12. The AP record manager module 60 will, over time, learn which of the APs 18 are more important than others, and keep the AP records for the important APs 18 in the memory 32, and preferably in the L1 AP cache 36, the L2 AP cache 38, or other layer of the AP cache, if any. The storage module 62 is configured to store the AP records in accordance with the learned importance of the AP records, e.g., storing the most important AP records (e.g., most likely to be used by the positioning module 70) in the L1 AP cache 36, less important AP records in the L2 AP cache 38, and still less important AP records in the tile storage 34. The learned importance of the AP records may be based on metrics determined by the metric module 64 and ranking of AP records (or equivalently APs) by the ranking module 66 as discussed below.

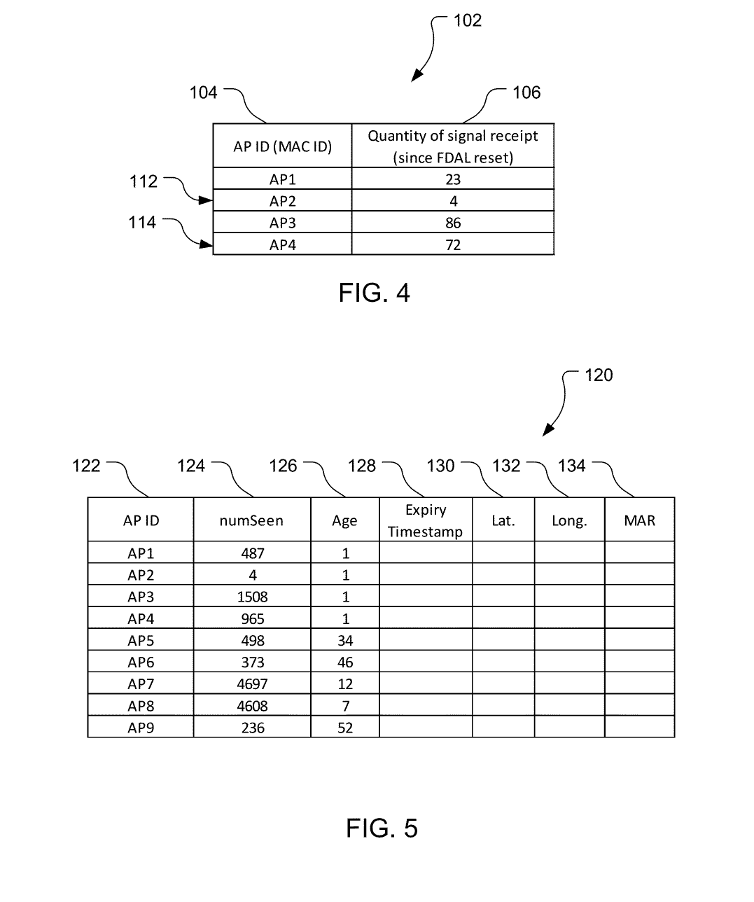

The metric module 64 is configured to collect and store one or more metrics for use in determining the likelihoods of use of the AP records corresponding to the APs 18. The metric module 64 is configured to discover the APs 18 from which signals are received by the mobile device 12 and to record recent usage information of these APs 18. For example, referring also to FIG. 4, the metric module 64 may monitor the receipt of signals from the APs 18, collect information as to the quantity of signals received from any particular one of the APs 18, and store this information, for example, in a Freshly Detected AP List (FDAL) 102. The FDAL 102 includes a column of AP IDs 104 and a column of quantities of signals received 106 since a last FDAL reset. The AP IDs 104 shown in the FDAL 102 are simplified IDs for reference purposes. Because mobile APs are preferably not used by the positioning module 70 to determine the location of the mobile device 12, the metric module 64 preferably does not include mobile APs in the FDAL 102.

The metric module 64 may monitor the signals received from the APs 18 by the mobile device 12 and increase the quantity of signals received 106 for each of the APs 18 each time a signal is received from that AP 18. In the example shown in FIG. 4, signals have been received by the mobile device 12 from AP1, AP2, AP3, and AP4 a total of 23, 4, 86, and 72 times, respectively. The metric module 64 may increase the quantity of signals received 106 only once in a window of time. For example, the metric module 64 may increase the counter for the quantity of signals received 106 once every 10 minutes, or other desired time window, for each of the APs from which at least one signal is received regardless of how many times a signal from a particular one of the APs 18 is received during that window. This constraint on the counter can limit the weight given to any of the APs 18 from which the mobile device 12 very frequently receives signals. Further, the quantity of signals received may be compared to a time frame over which the signals are received and thus expressed as a frequency of signals received.

The metric module 64 may be configured to reset the FDAL 102 intermittently. For example, the metric module 64 may reset the FDAL 102 every 24 hours, although other time durations may be used. Furthermore, the time duration between resets of the FDAL 102 may or may not be consistent. In the example of a reset every 24 hours, and if the reset occurs at midnight, then the FDAL 102 represents a list of the APs 18 detected by the mobile device 12 during the present day.

The metric module 64 may determine an amount of time since a signal was last received by the mobile device 12 from each of the APs 18 from which at least one signal has been received. The metric module 64 tracks an amount of time elapsed since the last signal was received by the mobile device 12 from each of the APs 18. For example, the metric module 64 may count time intervals since the last receipt of a signal from any particular one of the APs 18, and this metric is referred to as the Age of the AP 18. For example, the metric module 64 may increase a counter by one for each passage of the interval, e.g., 24 hours. Thus, for example, the metric module 64 may set an age counter to 1 for a particular AP 18 each time the AP 18 appears in the FDAL 102 and increment the age counter by one for the AP 18 each time the FDAL 102 is reset without the AP 18 appearing in the FDAL 102. In this example, the counter will typically increment from 1 to 2 with the passage of less than the full interval (unless the initial signal was received at the time of the FDAL being reset), but will increase beyond 2 in response to the mobile device 12 not having received a signal from the AP 18 in the last full interval (e.g., 24 hours, or other time duration between resets of the FDAL 102).

Referring also to FIG. 5, the storage module 62 is configured to store AP records in the tile storage 34, the L1 AP cache 36, and (if used) the L2 AP cache 38 (or other AP cache) as shown in a table 120. Each AP records entry in the table 120 includes fields of an AP ID 122, a number seen (numSeen) 124, and age 126, and expiry timestamp 128, a latitude 130, a longitude 132, and a maximum antenna range (MAR) 134. Values of the expiry timestamp 128, the latitude 130, the longitude 132, and the MAR 134 are omitted from the table 120 to reduce complexity of the table 120. As a non-limiting example, the AP ID 122 may be a media access control (MAC) ID and may be 8 bytes, the numSeen may be 4 bytes, the Age 126 may be 4 bytes, the expiry timestamp 128 may be 8 bytes, the latitude 130 may be 4 bytes, the longitude 132 may be 4 bytes, and the MAR 134 may be 4 bytes. The Age 126 is the counter discussed above that is maintained by the metric module 64 that counts time intervals since the last receipt of a signal from any particular one of the APs 18. The latitude 130 and the longitude 132 are the latitude and longitude coordinates of the AP 18. Similar to the metric module 64 not tracking information for mobile APs, because mobile APs are preferably not used by the positioning module 70 to determine the location of the mobile device 12, the storage module 62 preferably does not store AP records in the memory 32 for mobile APs.

The expiry timestamp 128 is a configurable parameter indicative of a time after which, an AP record will be removed if that AP has not been seen (e.g., the expiry timestamp could be a specific date, a specific date and time of day, or could be a timer that counts down since the last occurrence of the corresponding AP being seen, etc.). Thus, the expiry timestamp 128 is a configurable parameter indicative of an amount of time that may be used to remove old AP records corresponding to APs that have been inactive, i.e., from which signals have not been received, beyond a desired amount of time. The AP records are removed (although possibly moved to another storage area, e.g., a lesser-priority layer of the AP cache or to the tile storage 34) because they are unlikely to be used in positioning and thus it is desirable not to include the AP records in a search pool (at least in the L1 AP cache 36 or the L2 AP cache 38) when looking for positioning assistance data. The expiry timestamp supplements the Age 126 and helps ensure that records that would slow the accessing of desired records are removed to help reduce the time to access desired records. The expiry timestamp may be different for different layers of the AP cache such that a record may be removed from the L1 AP cache 36 after a shorter inactivity time than a record will be removed from the L2 AP cache 38.

The number seen 124 indicates a number of times that a signal has been received by the mobile device 12 from the corresponding AP 18 since an AP record for the AP 18 has been stored by the mobile device 12 without being reset. The number seen 124 is thus an aggregation of the quantity of signals received 106 from the FDAL 102 for each time that the AP 18 has appeared in the FDAL 102 since the AP 18 has had a record stored in the mobile device 12 without being reset. The storage module 62 may not reset an AP record for any of the APs 18, and in this case the number seen 124 would indicate the number of times the signal has been received by the mobile device 12 from the corresponding AP 18 since the AP record for the AP 18 has been stored by the mobile device 12. The storage module 62 may, however, reset at least the number seen 124 if the corresponding AP is relocated. Further, the storage module 62 may delete an AP record for any one of the APs 18 and store a new AP record for the AP 18 if a signal is thereafter received from the AP 18 by the mobile device 12. In this case, the storage module 62 will store the AP record with the number seen 124 indicating the quantity of signals received 106 determined by the metric module 64 and stored in the FDAL 102. The number seen 124 may be compared to a time frame, e.g., the amount of time that each record has been stored, and expressed as a frequency of receipt of signals.

The storage module 62 is configured to update the AP records for the APs 18 in the tile storage 34, the L1 AP cache 36, and the L2 AP cache 38 with the information from the FDAL 102 before resetting the FDAL 102. Thus, for example, the storage module 62 may update the AP records every 24 hours in the example of the FDAL 102 being reset every 24 hours.

The AP record manager module 60 is configured to perform an AP record evaluation process intermittently. For example, the AP record manager module 60 may evaluate the AP records each time that the FDAL 102 is reset or is to be reset. The record evaluation process helps ensure that records are stored at appropriate locations to help expedite accessing the records. The record evaluation process may result in one or more records being added to the AP cache, being removed from the AP cache, and/or being moved within the AP cache (e.g., from the L1 AP cache 36 to the L2 AP cache and/or vice versa).

In the AP record evaluation process, the AP record manager module 60 determines likelihoods of usage by the positioning module 70 for each of the AP records. The determined likelihoods may not be perfect and are thus estimated likelihoods of usage by the positioning module 70. As used throughout herein, an indication of a likelihood of use (or similar phrasing) of an AP record is equivalent to an estimation of the likelihood of use of the AP record. Further, a likelihood of use of an AP record may be referred to as a likelihood of use of an AP. The AP record manager module 60, and in particular the storage module 62, is configured to store the AP records in the appropriate portion of the memory 32 based on the determined likelihoods. The AP records are stored in order of descending likelihoods starting with the L1 AP cache 36, then the L2 AP cache 38 (if used), then any other layer AP cache in order, and then the tile storage 34. Thus, the AP records with the highest likelihoods of usage by the positioning module 70 are stored in the L1 AP cache 36. The highest likelihood AP records are preferably stored in the L1 AP cache 36 until the L1 AP cache 36 is full, then further AP records are stored in the other memories in the order indicated as each one of those memory locations is filled. Thus, upon each evaluation, an AP record in any of the caches of the AP cache having a lower likelihood than another AP record will be replaced by the higher-likelihood AP record.

The ranking module 66 is configured to rank the AP records in order of likelihood of usage by the positioning module 70. For example, the ranking module 66 may rank the likelihood of future use of the AP records based on historical use of the records, e.g., for days, times, and/or a general location that are similar to the present day, time, and/or general location. The ranking module 66 may be configured to rank the AP records according to any of a variety of techniques using one or more of various metrics. For example, the ranking module 66 may rank the AP records based on the number of times that a signal has been received from any particular one of the APs 18 in combination with the time interval since the last receipt of a signal from that AP. As an example of this technique, the ranking module 66 may determine an AP importance score (APImportanceScore) according to

APImportanceScore=freqRatio*numSeen−ageRatio*Age (1)

where freqRatio and ageRatio are positive numbers that are selected to provide a desired balance between the influence of numSeen and the influence of Age on the AP importance score, and numSeen and Age are defined above with respect to FIG. 5. The values of freqRatio and ageRatio provide a tradeoff in the APImportanceScore value between the quantities of signals received from the APs 18 by the mobile device 12 and a respective time since a most-recent receipt of a signal from each AP of the APs 18 from which at least one signal has been received by the mobile device 12.

The ranking module 66 may use still further criteria to determine the APImportanceScore or other measure of the likelihood of use of AP records by the positioning module 70 for determining position of the mobile device 12. For example, the ranking module 66 may weight APs 18 from which a signal was received within the last day (or the last similar day (e.g., work day vs. non-work day) as discussed below) higher than APs 18 from which the most-recently received signal was received more than a day ago, or on a previous day even if a signal was received within the last 24 hours. As another example, the ranking module 66 may use other criteria that may help the ranking module 66 determine likelihood of use of AP records within a defined future timeframe. In this case, for example, the ranking module 66 may factor in the day of the week (e.g., weekday versus weekend day) and/or time of day to rank the AP records. AP records corresponding to APs 18 near a user's home may be ranked higher on weekend days and on weekdays before 8 AM and after 6 PM than during other times. Similarly, the AP records in the memory 32 corresponding to APs 18 at or near the user's place of business may be ranked higher between the hours of 8 AM and 6 PM on weekdays that are not holidays than during other times. The ranking module 66 could store different rankings depending on different criteria, e.g., one ranking for work hours and another ranking for non-work hours. Still further criteria may be used to determine the ranking of the AP records.

The storage module 62 is configured to work in conjunction with the ranking module 66 and to store the AP records in the memory 32. The storage module 62 receives the APImportanceScore values from the ranking module 66 for the APs 18 whose AP records are stored in the memory 32, e.g., in at least one of the tile storage 34, the AP cache (including the L1 AP cache 36 and any other layers of AP cache such as the L2 AP cache 38), or that have an entry in the FDAL 102. The storage module 62 stores the AP records based on the, e.g., in, order of their respective APImportanceScore values in the memory 32, in the order of the L1 AP cache 36, the L2 AP cache 38 (if used), any further AP caches, then the tile storage 34. Thus, if the capacity of the L1 AP cache 36 is X records, then the X-highest-ranked records will be stored in the L1 AP cache 36, although the records may not be stored exactly in order inside the L1 AP cache 36 (or any other storage). Thus, each time that the AP records are evaluated and stored, the AP record corresponding to a particular one of the APs 18 may be moved from one portion of the memory 32 to another, e.g., from the L1 AP cache 36 to the L2 AP cache 38 or vice versa.

The storage module 62 may further be configured to update information in the AP records stored in the memory 32. Information for the AP records may change over time. Thus, the storage module 62 may be configured to intermittently query the server 16 for present information for the AP records and use the present information for the AP records stored in the memory 32. Consequently, new positioning assistance information will replace outdated information in the AP records, thus updating the AP records in the mobile device 32. For example, the storage module 62 may query the server 16 for present information for the AP records once every 24 hours, or other time interval. The querying by the storage module 62 of the server 16 for present information for the AP records may be performed periodically (with a consistent time interval between queries), aperiodically, or a combination of periodically and aperiodically.

The storage module 62 may further be configured to force retirement of an AP record, e.g., according to the expiry timestamp 128. The storage module 62 may be configured to remove an AP record from the memory 32 in response to a threshold amount of time being exceeded since the last receipt of a signal by the mobile device 12 from the AP 18 corresponding to that AP record. For example, if no signal has been received from a particular one of the APs 18 for 60 days, then the storage module 62 may remove the AP record corresponding to the particular AP 18. Thus, even if an AP 18 had an APImportanceScore value that was high enough to justify being stored in the memory 32, e.g., because there was a high value for numSeen, the AP record corresponding to that AP 18 may be deleted due to an inactivity period. The threshold amount of time of 60 days is an example only and other amounts of time may be used.

The positioning module 70 is configured to access the AP records stored in the memory 32 in order to determine the position of the mobile device 12. The positioning module 70 is configured to first access the AP records in the L1 AP cache 36 in order to determine the position of the mobile device 12. If more positioning assistance data are desired, e.g., to determine the position of the mobile device 12 with more accuracy, then the positioning module 70 will access further AP records from the L2 AP cache 38 (if available), then further AP caches (if available), then the tile storage 34. For example, if fewer than a threshold number of AP records are stored in the AP cache that correspond to APs 18 on a scan list (e.g., from which the mobile device 12 received a signal during a most-recent scan), then the positioning module 70 may attempt to access AP records for more of the APs 18 on the scan list from the tile storage 34. As another example, if a percentage of APs in the scan list for which there are AP records in the AP cache is below a threshold amount, then the positioning module 70 may attempt to access AP records for more of the APs 18 on the scan list from the tile storage 34. The threshold number of AP records and/or the threshold percentage of APs (e.g., 25%, 40%, or other) are configurable parameters. If still further AP records are desired for the desired positioning accuracy after accessing the tile storage 34, then the positioning module 70 may initiate a server access to request positioning assistance data from the server 16, for example for one or more tiles not presently stored by the memory 32 and/or for updated AP record information for one or more tiles presently stored by the memory 32.

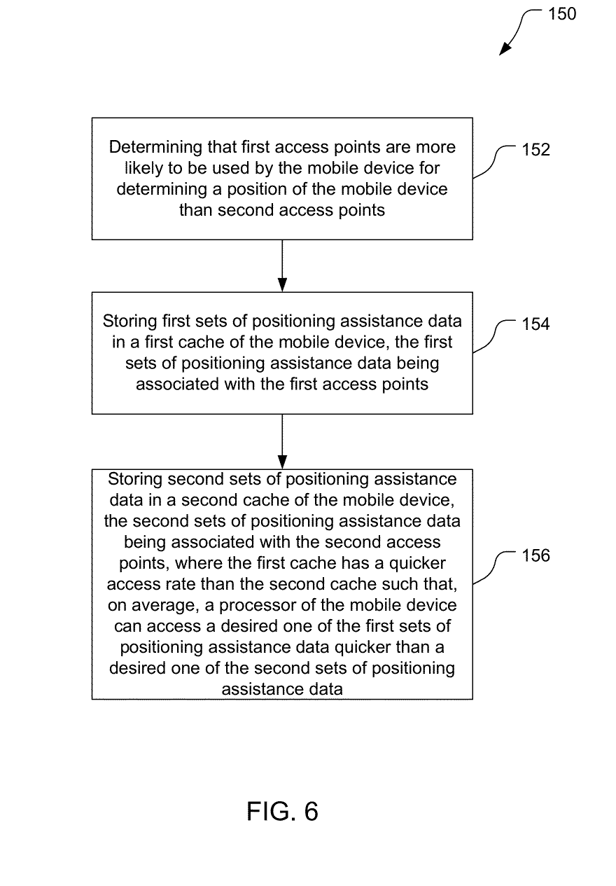

Referring to FIG. 6, with further reference to FIGS. 1-5, a process 150 of organizing positioning assistance data includes the stages shown. The process 150 is, however, an example only and not limiting. The process 150 can be altered, e.g., by having stages added, removed, rearranged, combined, performed concurrently, and/or having single stages split into multiple stages.

At stage 152, the process 150 includes determining that first access points are more likely to be used by a mobile device for determining a position of the mobile device than second access points. The processor module 50 determines that some of the APs 18 are more likely than other APs 18 to be used by the positioning module 70 for determining the location of the mobile device 12. For example, the ranking module 66 ranks (preferably all, i.e., each of) the APs 18 stored in the memory 32 according to the likelihood of future use by the positioning module 70 for determining the position of the mobile device 12. The ranking module 66 may determine the ranking based on quantities of signals received from the APs 18. The ranking module 66 may employ a tradeoff between the quantities of signals received from the APs 18 by the mobile device 12 and respective times since most-recent receipts of signals from the APs 18. For example, the ranking module 66 may rank the AP records (which is equivalent to ranking the APs 18) according to equation (1). The ranking module 66 may rank the AP records using techniques other than equation (1), including using criteria other than those used in equation (1), instead of or in addition to equation (1). The ranking may be performed as discussed above, for example with the metric module 64 populating the FDAL 102, using the FDAL 102 to update the AP records in the memory 32 intermittently, and clearing the FDAL 102. Further, the storage module 62 may intermittently update the AP records stored in the memory 32 by querying the server 16 for present information for the AP records.

At stage 154, the process 150 includes storing first sets of positioning assistance data in a first cache of the mobile device, the first sets of positioning assistance data being associated with the first access points. For example, the storage module 62 stores the AP records associated with the first access points in the L1 AP cache 36. The storage module 62 may store the AP records corresponding to the APs 18 that are ranked highest by the ranking module 66 until the L1 AP cache 36 is filled.

At stage 156, the process 150 includes storing second sets of positioning assistance data in a second cache of the mobile device, the second sets of positioning assistance data being associated with the second access points, where the first cache has a quicker access rate than the second cache such that, on average, a processor of the mobile device can access a desired one of the first sets of positioning assistance data quicker than a desired one of the second sets of positioning assistance data. For example, the storage module 62 stores the AP records associated with the second access points in the L2 AP cache 38. The storage module 62 may store the AP records that are not stored in the L1 AP cache 36 in order of rank provided by the ranking module 66 until the L2 AP cache 38 is filled. The storage module 62 may store fewer AP records in the L1 AP cache 36 than in the L2 AP cache 38.

The process 150 may include further stages that are not shown and/or one or more further operations in one or more of the stages shown. For example, the process 150 may include removing respective ones of the first sets of positioning assistance data from the first cache in response to a threshold amount of time passing without receiving signals from corresponding ones of the first access points by the mobile device. The storage module 62 may enforce a retirement time threshold in order to remove AP records corresponding to interactive APs, that is, APs from which the mobile device 12 has not received a signal within a retirement threshold amount of time. Further, the process 150 may include eliminating from consideration as either one of the first access points or one of the second access points, any access point that is identified as a mobile access point. The storage module 62 may omit from storage in the memory 32 any AP record corresponding to one of the APs 18 that is a mobile AP, e.g., as indicated by the AP 18 in signals sent to the mobile device 12 and/or as indicated by the server 16.

The positioning module 70 may use the stored AP records to determine the position of the mobile device 12. The positioning module 70 may attempt to access the AP records corresponding to the APs 18 in a scan list stored in the memory 32. The positioning module 70 may use the information in the AP records corresponding to APs in the scan list, along with information in or derived from signals received from the APs 18, to determine the location of the mobile device 12. The positioning module 70 will attempt to access the AP records starting first with the L1 AP cache 36, then the L2 AP cache 38 (if used), then any further caches in the AP cache, then the tile storage 34. If the positioning module 70 is able to determine the location of the mobile device 12 with a desired degree of accuracy, then the positioning module 70 may only search the L1 AP cache 36 for AP records. For example, the positioning module 70 may only search beyond the L1 AP cache 36 if there are less than a threshold number of the APs 18 in the scan list corresponding to AP records in the L1 AP cache 36 or if the number of the APs 18 in the scan list corresponding to AP records in the L1 AP cache 36 divided by the total number of the APs 18 in the scan list is below a threshold percentage. If, after searching the AP cache and the tile storage 34, the positioning module 70 desires still further AP records, then the positioning module 70 may query the server 16 for additional positioning assistance data.

Other Considerations

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A alone, or B alone, or C alone, or AB, or AC, or BC, or ABC (i.e., A and B and C), or combinations with more than one of the same feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include that the information is conveyed from a sending entity but does not reach an intended recipient of the information. The intended recipient, even though not actually receiving the information, may still be referred to as a receiving entity, e.g., a receiving execution environment.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

1. A method of organizing positioning assistance data in a mobile device, the method comprising:
determining that first access points are more likely to be used by the mobile device for determining a position of the mobile device than second access points, the first access points being distinct from the second access points, the first access points and the second access points being members of a master group of access points associated with positioning assistance data stored by the mobile device, at least the first access points being access points from the master group of access points from each of which at least one signal has been received by the mobile device;
storing first sets of positioning assistance data in a first cache of the mobile device, the first sets of positioning assistance data being associated with the first access points; and
storing second sets of positioning assistance data in a second cache of the mobile device, the second sets of positioning assistance data being associated with the second access points;
wherein the first cache has a quicker access rate than the second cache such that, on average, a processor of the mobile device can access a desired one of the first sets of positioning assistance data quicker than a desired one of the second sets of positioning assistance data.

2. The method of claim 1, wherein storing the first sets of positioning assistance data comprises storing the first sets of positioning assistance data in the first cache such that the first cache stores fewer sets of positioning assistance data than the second cache stores.

3. The method of claim 1, wherein the determining that first access points are more likely to be used by the mobile device for determining a position of the mobile device than second access points comprises ranking access points in the master group of access points in order of likelihood of future use by the mobile device for determining the position of the mobile device.

4. The method of claim 3, wherein the ranking access points in the master group of access points is based on quantities of signals received by the mobile device from respective access points in the master group of access points.

5. The method of claim 4, wherein the ranking comprises a tradeoff between the quantities of signals received by the mobile device from the respective access points in the master group of access points and respective times since most-recent receipts of signals by the mobile device from respective access points in the master group of access points.

6. The method of claim 1, further comprising removing respective ones of the first sets of positioning assistance data from the first cache in response to a threshold amount of time passing without receiving a signal from each of corresponding ones of the first access points by the mobile device.

7. The method of claim 1, further comprising eliminating from consideration, as either one of the first access points or one of the second access points, any access point that is identified as a mobile access point.

8. A mobile device comprising:
a processor;
a first cache communicatively coupled to the processor; and
a second cache communicatively coupled to the processor;
wherein the first cache has a quicker access rate than the second cache such that, on average, the processor can access positioning assistance data stored in the first cache quicker than the processor can access positioning assistance data stored in the second cache; and
wherein the processor is configured to:
determine that first access points are more likely to be used by the mobile device for determining a position of the mobile device than second access points, the first access points being distinct from the second access points, the first access points and the second access points being members of a master group of access points associated with positioning assistance data stored by the mobile device, at least the first access points being access points from the master group of access points from each of which at least one signal has been received by the mobile device;
store first sets of positioning assistance data in the first cache, the first sets of positioning assistance data being associated with the first access points; and
store second sets of positioning assistance data in the second cache, the second sets of positioning assistance data being associated with the second access points.

9. The mobile device of claim 8, wherein a storage capacity of the first cache is smaller than a storage capacity of the second cache.

10. The mobile device of claim 8, wherein to determine that first access points are more likely to be used by the mobile device for determining a position of the mobile device than second access points the processor is configured to rank access points in the master group of access points in order of likelihood of future use by the mobile device for determining the position of the mobile device.

11. The mobile device of claim 10, wherein the processor is configured to rank access points in the master group of access points based on quantities of signals received by the mobile device from respective access points in the master group of access points, and wherein the first access points are ranked at least as high as a highest-ranked one of the second access points.

12. The mobile device of claim 11, wherein the processor is configured to rank the access points according to a tradeoff between the quantities of signals received by the mobile device from the respective access points in the master group of access points and respective times since most-recent receipts of signals by the mobile device from the respective access points in the master group of access points.

13. The mobile device of claim 8, wherein the processor is further configured to remove respective ones of the first sets of positioning assistance data from the first cache in response to a threshold amount of time passing without receiving a signal from each of corresponding ones of the first access points by the mobile device.

14. The mobile device of claim 8, wherein the processor is further configured to eliminate from consideration as either one of the first access points or one of the second access points, any access point that is identified as a mobile access point.

15. A non-transitory processor-readable storage medium, in a mobile device, comprising processor-readable instructions configured to cause a processor to:
determine that first access points are more likely to be used by the mobile device for determining a position of the mobile device than second access points, the first access points being distinct from the second access points, the first access points and the second access points being members of a master group of access points associated with positioning assistance data stored by the mobile device, at least the first access points being access points from the master group of access points from each of which at least one signal has been received by the mobile device;
store first sets of positioning assistance data in a first cache of the mobile device, the first sets of positioning assistance data being associated with the first access points; and
store second sets of positioning assistance data in a second cache of the mobile device, the second sets of positioning assistance data being associated with the second access points;
wherein the first cache has a quicker access rate than the second cache such that, on average, a processor of the mobile device can access a desired one of the first sets of positioning assistance data quicker than a desired one of the second sets of positioning assistance data.

16. The storage medium of claim 15, wherein the instructions configured to store the first sets of positioning assistance data comprise instructions configured to cause the processor to store the first sets of positioning assistance data in the first cache such that the first cache stores fewer sets of positioning assistance data than the second cache stores.

17. The storage medium of claim 15, wherein the instructions configured to cause the processor to determine that the first access points are more likely to be used by the mobile device for determining the position of the mobile device than the second access points comprise instructions configured to cause the processor to rank access points in the master group of access points in order of likelihood of future use by the mobile device for determining the position of the mobile device.

18. The storage medium of claim 17, wherein the instructions configured to cause the processor to rank access points in the master group of access points comprise instructions configured to cause the processor to rank access points in the master group of access points based on quantities of signals received by the mobile device from respective access points in the master group of access points.

19. The storage medium of claim 18, wherein the instructions configured to cause the processor to rank access points in the master group of access points comprise instructions configured to cause the processor to rank each of the respective access points in the master group of access points based on a tradeoff between the quantities of signals received by the mobile device from the respective access points in the master group of access points and respective times since most-recent receipts of signals by the mobile device from the respective access points in the master group of access points.

20. The storage medium of claim 15, further comprising instructions configured to cause the processor to remove respective ones of the first sets of positioning assistance data from the first cache in response to a threshold amount of time passing without receiving a signal from each of corresponding ones of the first access points by the mobile device.

21. The storage medium of claim 15, further comprising instructions configured to cause the processor to eliminate from consideration as either one of the first access points or one of the second access points, any access point that is identified as a mobile access point.

22. A mobile device comprising:
processing means;
a first cache communicatively coupled to the processing means; and
a second cache communicatively coupled to the processing means;
wherein the first cache has a quicker access rate than the second cache such that, on average, the processing means can access positioning assistance data stored in the first cache quicker than the processing means can access positioning assistance data stored in the second cache; and
wherein the processing means comprise:
means for determining that first access points are more likely to be used by the mobile device for determining a position of the mobile device than second access points, the first access points being distinct from the second access points, the first access points and the second access points being members of a master group of access points associated with positioning assistance data stored by the mobile device, at least the first access points being access points from the master group of access points from each of which at least one signal has been received by the mobile device;
means for storing first sets of positioning assistance data in the first cache, the first sets of positioning assistance data being associated with the first access points; and
means for storing second sets of positioning assistance data in the second cache, the second sets of positioning assistance data being associated with the second access points.

23. The mobile device of claim 22, wherein a storage capacity of the first cache is smaller than a storage capacity of the second cache.

24. The mobile device of claim 22, wherein the means for determining that the first access points are more likely to be used by the mobile device for determining a position of the mobile device than second access points the processing means are for ranking access points in the master group of access points in order of likelihood of future use by the mobile device for determining the position of the mobile device.

25. The mobile device of claim 24, wherein the means for ranking access points in the master group of access points are for ranking access points in the master group of access points based on quantities of signals received by the mobile device from respective access points in the master group of access points, and wherein the first access points are ranked at least as high as a highest-ranked one of the second access points.

26. The mobile device of claim 25, wherein the means for ranking access points in the master group of access points are for ranking each of the respective access points in the master group of access points according to a tradeoff between the quantities of signals received by the mobile device from the respective access points in the master group of access points and respective times since most-recent receipts of signals by the mobile device from the respective access points in the master group of access points.

27. The mobile device of claim 22, wherein the processing means further comprise means for removing respective ones of the first sets of positioning assistance data from the first cache in response to a threshold amount of time passing without receiving a signal from each of corresponding ones of the first access points by the mobile device.

28. The mobile device of claim 22, wherein the processing means further comprise means for eliminating from consideration as either one of the first access points or one of the second access points, any access point that is identified as a mobile access point.
